(19) United States
(12) Patent Application Publication
(10) Pub. No.: US 2013/0278750 A1
(43) Pub. Date: Oct. 24, 2013

(54) SELF-LEARNING MACHINE VISION SYSTEM

(71) Applicant: METROSPEC TECHNOLOGY, L.L.C., Mendota Heights, MN (US)

(72) Inventor: Eric Henry Holec, Mendota Heights, MN (US)

(73) Assignee: METROSPEC TECHNOLOGY, L.L.C., Mendota Heights, MN (US)

(21) Appl. No.: 13/866,297

(22) Filed: Apr. 19, 2013

Related U.S. Application Data
(60) Provisional application No. 61/637,059, filed on Apr. 23, 2012.

(51) Int. Cl. H04N 7/18

(52) U.S. Cl. CPC H04N 7/18
USPC 348/87

(57) ABSTRACT

Embodiments of the invention include systems and methods relating to self-learning machine vision systems. In an embodiment, the invention includes a self-learning machine vision system including a video input; a processor in communication with the video input; and a video output in communication with the processor. The processor is configured to process video data from the video input and identify a number of repeating units within the video data. The processor is further configured to identify repeating units that deviate from the other repeating units. The system can further display an image of the repeating units through the video output with indicia to indicate identified deviant repeating units. In an embodiment, the invention includes a method of identifying defects in a stream of produced items including processing video data from a video input with a computing system; identifying a number of repeating units within the video data; identifying repeating units that deviate from the other repeating units by comparing the repeating with one another; and displaying an image of the repeating units through a video output with indicia to indicate identified deviant repeating units. Other embodiments are also included herein.

This application claims the benefit of U.S. Provisional Application No. 61/637,059 filed Apr. 23, 2012, the contents of which are herein incorporated by reference.

### FIELD OF THE INVENTION

The present invention relates to self-learning machine vision systems and methods.

### BACKGROUND OF THE INVENTION

Machine vision systems have many applications including security systems, process automation systems, quality control systems such as automated inspection systems, smart devices, robotics, navigation systems, and the like.

Automated inspection is vital component to manufacturing. Inspection using machine vision allows for early detection of errors and high throughput. Additionally, unlike human operators, machine vision systems tend to be more consistent and are not prone to fatigue, illness, and other human maladies that may impact performance.

### SUMMARY OF THE INVENTION

Embodiments of the invention include systems and methods relating to self-learning machine vision systems. In an embodiment, the invention includes a self-learning machine vision system including a video input; a processor in communication with the video input; and a video output in communication with the processor. The processor is configured to process video data from the video input and identify a number of repeating units within the video data. The processor is further configured to identify repeating units that deviate from the other repeating units. The system can further display an image of the repeating units through the video output with indicia to indicate identified deviant repeating units.

In an embodiment, the invention includes a method of identifying defects in a stream of produced items including processing video data from a video input with a computing system; identifying a number of repeating units within the video data; identifying repeating units that deviate from the other repeating units by comparing the repeating with one another; and displaying an image of the repeating units through a video output with indicia to indicate identified deviant repeating units.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a schematic view of a system in accordance with an embodiment herein.

FIG. 2 is a flow chart in accordance with various embodiments herein.

FIG. 3 is a view of an article that can be analyzed in accordance with embodiments herein.

FIG. 4 is a flow chart in accordance with various embodiments herein.

FIG. 5 is a view of an article with key points superimposed thereon in accordance with various embodiments herein.

FIG. 6 is a view of an article with corners of repeating units identified thereon in accordance with various embodiments herein.

FIG. 7 is a view of an article with boundaries superimposed thereon in accordance with various embodiments herein.

FIG. 8 is a schematic diagram of an article including repeating units showing a grid for analysis in accordance with various embodiments herein.

FIGS. 9A and 9B show views of repeating units with and without background subtraction.

FIGS. 10A and 10B show views of repeating units with and without marking to indicate the location of the defect.

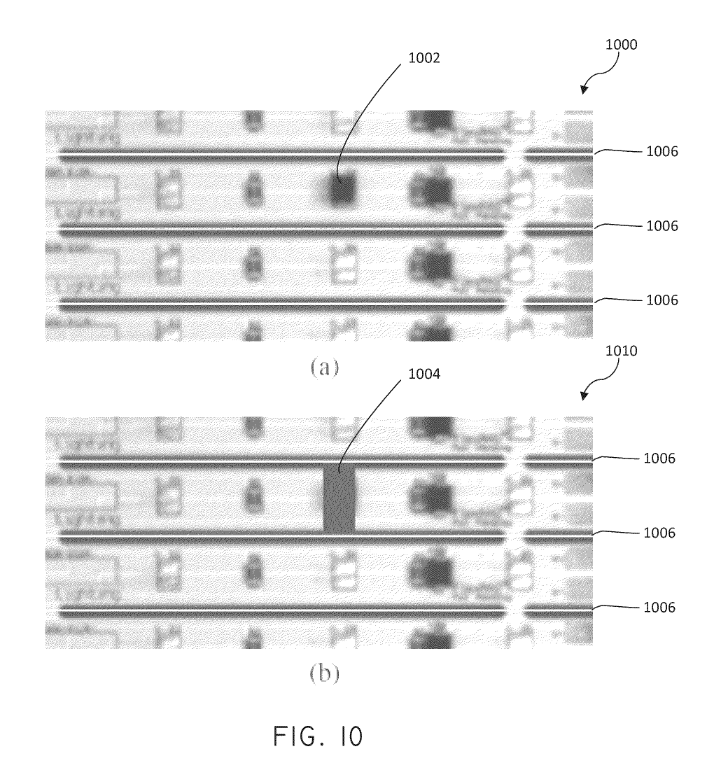

FIG. 11 shows a view of an article with marking superimposed thereon to indicate the location of the defects.

FIG. 12 is a schematic diagram of some components of an exemplary computing device in accordance with various embodiments herein.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Embodiments herein include systems and methods relating to self-learning machine vision systems. In an embodiment, the invention includes a self-learning machine vision system including a video input, a processor, and a video output. The system is configured to process video data from the video input and identify a number of repeating units within the video data and further identify repeating units that deviate from the other repeating units. The system can further display an image of the repeating units through the video output with indicia to indicate identified deviant repeating units. In various embodiments herein, the system is self-learning in the sense that it can process video images and identify deviant repeating units without going through a training process first. This is in contrast to, and represents a significant advance over, systems that must be programmed with the correct layout of an article or portions thereof or otherwise trained in advance.

### System

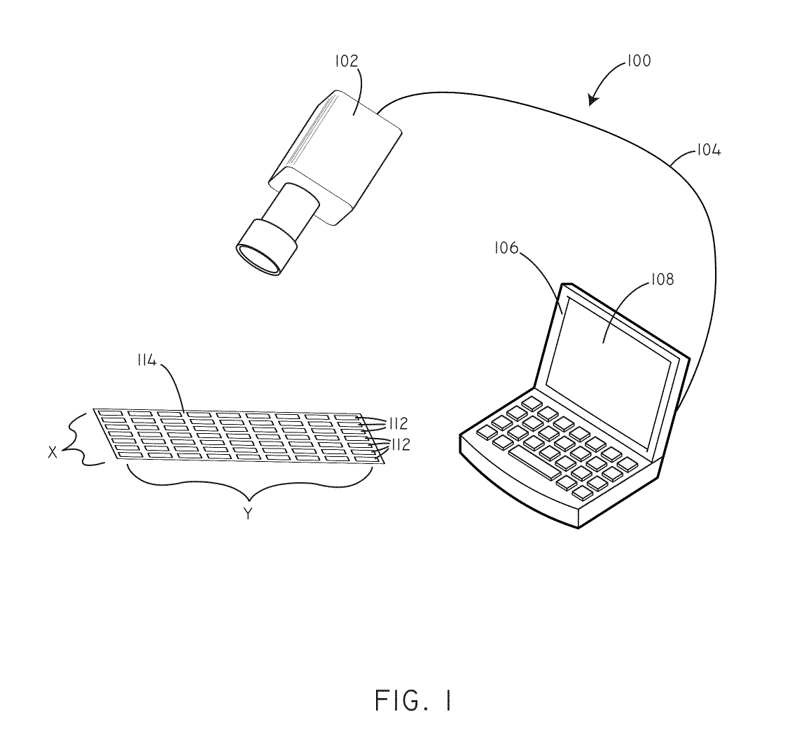

Referring now to FIG. 1, a system 100 is shown in accordance with an embodiment herein. The system includes a video input device 102 and a computing device 106. In this embodiment, the video input device 102 and the computing device 106 are connected via a cable 104, however, it will be appreciated that wireless communication is also contemplated herein. The computing device 106 can include a video output 108. The video input device 102 can be directed toward a work piece 114 that includes a plurality of repeating units 112. In this embodiment, the work piece 114 includes a plurality of repeating units 112 in both the crosswise X direction and the lengthwise Y direction.

It will be appreciated that various video input devices can be used in accordance with embodiments herein. In some embodiments, the video input device can be a video camera. In other embodiments, the video input device can be a still-frame photographic device. In some embodiments, the video input device can be, or include, an X-ray device, a thermal sensing device, or other electromagnetic spectrum-based sensing device.

Various video resolutions can be used in accordance with embodiments herein. In general, the use of high resolution cameras provides more data regarding the work piece 114 and the repeating units 112 thereon allowing for more precise identification of repeating units and identification of deviant repeating units. In some embodiments the camera provides an image with a resolution of at least about 800×600. In some embodiments the camera provides an image with a resolution of at least about 1600×1200.

In some embodiments, a desirable camera resolution is also impacted by the distance between the video input device and the pieces to be analyzed (e.g., the repeating units). In some embodiments, the distance between the video input device and the pieces to be analyzed is between about 0.1 meters and 10 meters. In some embodiment, the distance between the video input device and the pieces to be analyzed is between about 0.1 meters and 5 meters. It will be appreciated also that a lens having various magnifications can be used with video input devices herein.

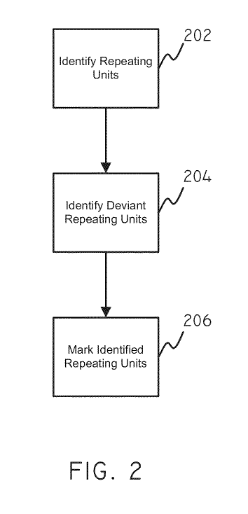

Referring now to FIG. 2, a flow chart of an embodiment herein is shown. In one operation 202, the system can identify repeating units. It will be appreciated that there are various techniques that can be used to identifying repeating units. Aspects of various exemplary approaches are described in greater detail below. In another operation 204, the system can identify deviant repeating units. Again, it will be appreciated that there are various techniques that can be used to identify deviant repeating units. Aspect of various exemplary approaches are described in greater detail below. In another operation 206, the system can mark identified repeating units. Marking can take place in order to flag those identified repeating units, or portions thereof, for further action.

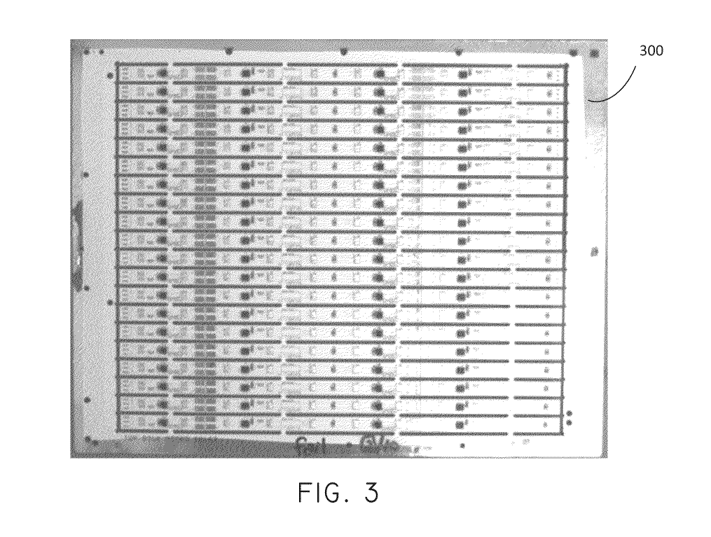

It will be appreciated that the systems and methods herein can be used to identify defects and/or abnormalities in a variety of different types of objects. For example, in some embodiments, the repeating units can be circuit boards, or portions thereof. For example, referring now to FIG. 3, a view of parallel circuit boards attached together is shown. In some embodiments, the repeating units can be various articles of manufacture. In some embodiments, the repeating units can be various consumer goods or components thereof.

In some embodiments, the repeating units can all be part of one physically attached unit or article. In other embodiments, the repeating units can all be arranged together for purposes of analysis, but can be physically separate. In some embodiments, the repeating units can be physically separate from one another and arranged on a tray or carrier for purposes of analysis in accordance with embodiments herein.

### Identifying Repeating Units

In various embodiments, the system is configured to automatically identify repeating subunits in the image data. In some embodiments, the repeating subunits can be in the Y axis (referring to FIG. 1). In other embodiments, the repeating subunits can be in the X axis (again, referring to FIG. 1). In some embodiments, the repeating subunits are co-temporal within the video data from the video input. For example, all of the repeating subunits would be contained within a single video frame of data coming from the video input. In other embodiments, the repeating subunits are not co-temporal within the video data from the video input.

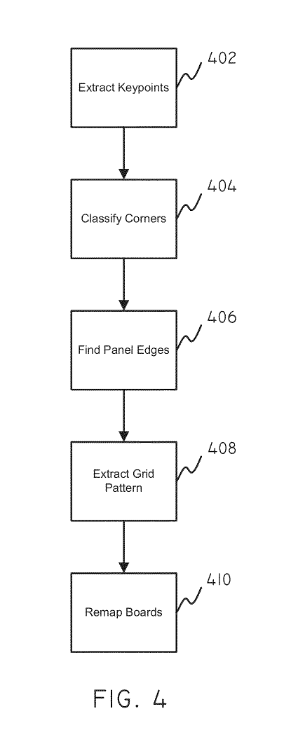

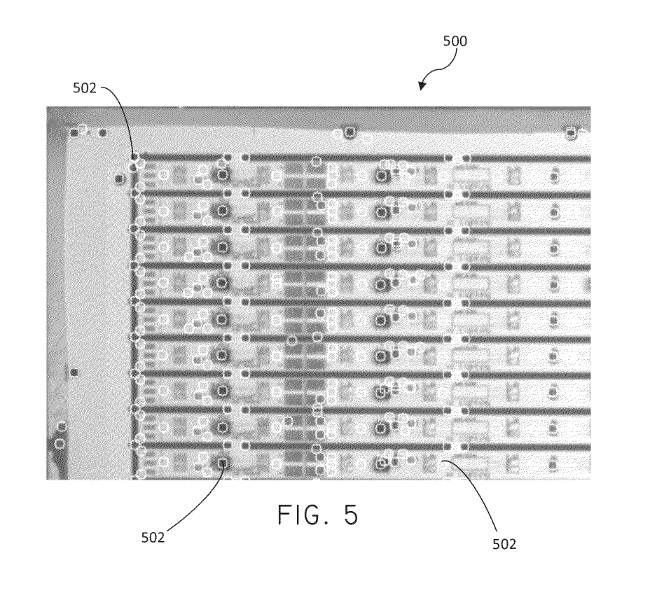

It will be appreciated that there are various techniques that can be used in order to identify repeating units. In some embodiments, identifying repeating units can include formation of a grid which separates the repeating units into segments representing equal areas of analysis. Referring now to FIG. 4, a flow chart is shown illustrating one approach for identifying repeating units. It should be understood, however, that this example is not limiting. In this particular approach, an operation 302 where key points are extracted from the image data is included. Key points are frequently of high contrast and contain a recognizable structure. It will be appreciated that there are various techniques that can be used for automatically extracting key points from image data. In some embodiments, a multi-scale Hessian key point detector can be used. Such a detector will automatically identify points of interest that can be useful in the process of identifying repeating units. Referring now to FIG. 5, an image of an article 500 is shown with select key points 502 indicated thereon.

In some embodiments, such as in the case of analyzing items including corners, an operation of classifying corners 304 can be included. As part of this operation, optionally, feature descriptors can be calculated. Various techniques can be used to calculate feature descriptors. One approach is known as SURF (Speeded Up Robust Features). An exemplary technique is described in U.S. Publ. Pat. App. No. 2009/238460, the content of which is herein incorporated by reference.

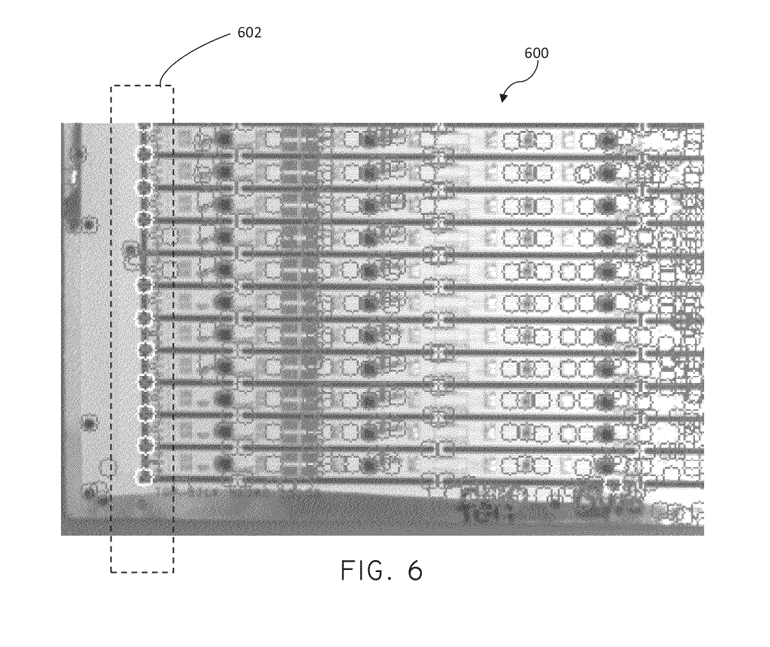

Further, as part of this operation 304, optionally, the feature descriptors can be classified using a support vector machine. For example, if there is a large number of feature descriptors and/or key points, then a technique can be used in order to classify the same, such as using a support vector machine. In general, a support vector machine takes a set of input data and predicts, for each given input, which of two possible classes the input is a member of, which makes the SVM a non-probabilistic binary linear classifier. Given a set of training examples, each marked as belonging to one of two categories, an SVM training algorithm builds a model that assigns new examples into one category or the other. It will be appreciated that in some embodiments SVM training may only occur a single time or may never occur. In some embodiments, the equivalent of SVM training data is preprogrammed into the system and thus SVM training may never need to be performed. Referring now to FIG. 6, a view of an article 600 is shown with corners (highlighted within box 602) of repeating units identified thereon in accordance with various embodiments herein.

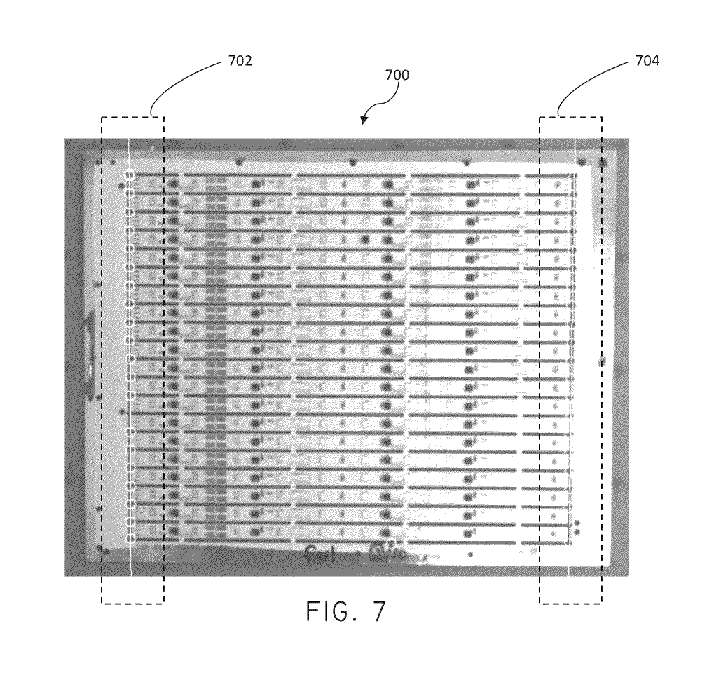

An operation of finding the edges 306 (or boundaries) of items to be analyzed, such as panels, can be included. In some embodiments, this can include locating the boundaries of the image to be analyzed. Various techniques can be used in order to identify such boundaries. In some embodiments, this can involve calculating the parameters of a line(s) that passes through certain of the feature descriptors and/or key points. For example, in some embodiments, this can involve calculating the parameters of a line(s) that passes through a plurality of corners of repeating units. In the context of a vertical line passing through multiple points, the desired line can be one that minimizes the sum of the squared horizontal distances between the line and each of the feature descriptors and/or key points to which it is being matched. Various techniques can be used to accommodate the presence of outliers. By way of example, a technique such as RANSAC (random sample consensus) can be used. RANSAC is an iterative method to estimate parameters of a mathematical model from a set of observed data which contains outliers. Referring now to FIG. 7, a view of an article 700 with boundaries (within boxes 702 and 704) superimposed thereon in accordance with various embodiments herein.

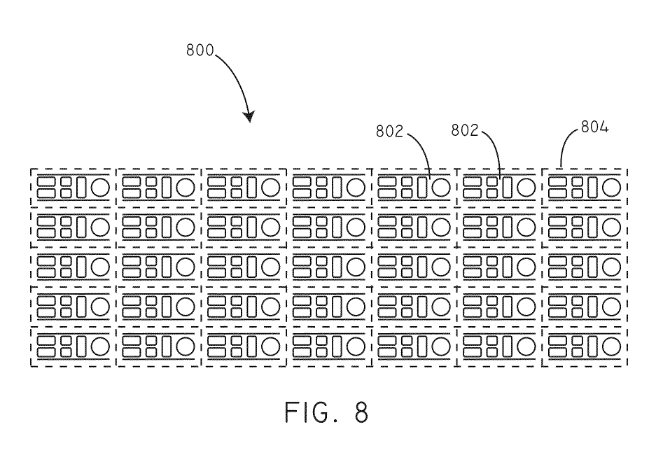

In some embodiments, a step of grid pattern extraction 308 can be performed. It will be appreciated that various techniques can be used in order to extract a grid pattern from a video image. In some embodiments, the grid can include a single column, but multiple rows. Then, each of the rows, or portions thereof, are compared against one another. In other embodiments, the grid can include a single row, but multiple columns. Then, each of the columns, or portions thereof, are compared against one another. In still other embodiments, the grid can include a multiple columns and rows. Then, each of the individual grid segments, or portions thereof, are compared against one another. Referring now to FIG. 8, a view of an article 800 with a plurality of repeating units 802 is shown with a grid 804 superimposed thereon that divides the repeating units 802 into portions that can be compared with one another. It will be appreciated that in the figures herein, superimposed elements are provided for purposes of illustration and such images may or may not be actually rendered in accordance with embodiments herein.

In some embodiments, an operation of remapping component parts to be analyzed 310, such as boards, can be executed. For example, in some embodiments, after identifying the overall pattern of repeating units, the video data for each of the repeating units can be processed in order to render each of them as identically dimensioned images. In some embodiments, input can be provided to the system regarding the number of repeating units in the X axis as well as the number of repeating units in the Y axis. With this information in hand, the system can then more directly proceed to identifying an overall pattern of repeating units within the video image data.

### Identifying Deviant Repeating Units

In various embodiments, the system can identify deviant repeating units. In some embodiments, the deviant repeating units correspond to defects in the materials being analyzed. In some embodiments, background subtraction is used in order to identify defects in the panels. Specifically, background subtraction can be performed on the identified repeating units with respect to one another. It will be appreciated that there are many different background subtraction methods and/or algorithms. An exemplary background subtraction technique includes, but is not limited to, the eigenbackground technique.

In some background subtraction techniques, only a single background model should exist. There are various techniques for obtaining a single background model. By way of example, in some embodiments the first repeating unit can be used for the single background model. In other embodiments, a random repeating unit can be used for the single background model. To account for the circumstance where the particular repeating unit to be used as a background model itself contains an aberration or defect, the system can be caused to repeat the identification process using a different repeating unit for the background model if the error rate exceeds a threshold value. By way of example, if the error rate exceeds 50% then the system can automatically repeat the identification process using a different repeating unit as the background model.

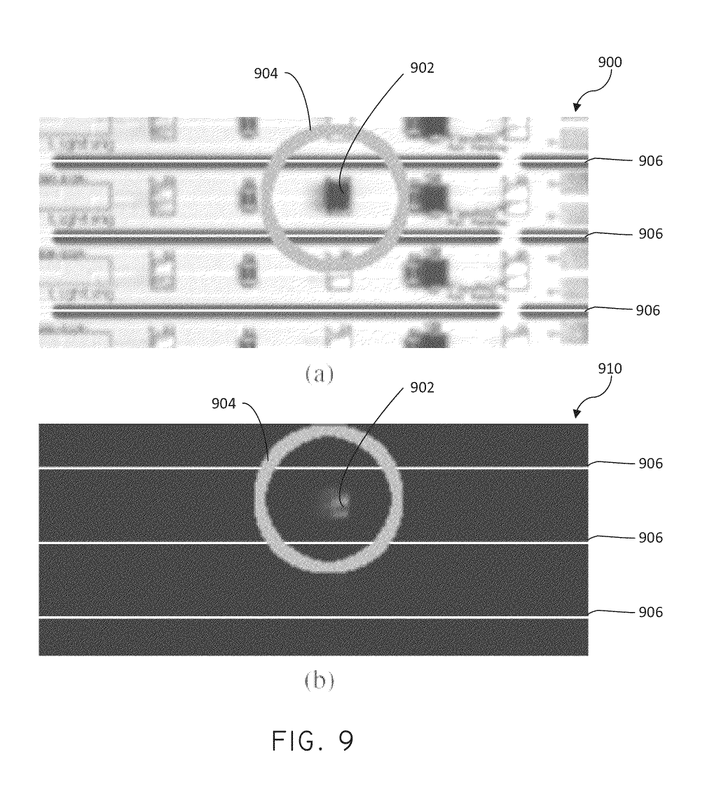

Referring now to FIGS. 9A and 9B, views are shown of repeating units with and without background subtraction to illustrate the output of a comparison operation. FIG. 9A shows portions of multiple repeating units as separated by grid lines 906. A defect 902 is shown within circle 904, which represents an aberration in comparison with the other repeating units. In FIG. 9B, background subtraction has been performed. In this view it can be seen that the portions that match with other repeating units are simply rendered in black and the portion that represents an aberration or defect 902 is rendered in white. It will be appreciated that the particular colors used herein are not significant and that any colors could be used.

In various embodiments, the repeating unit image can be projected onto the background model and then reprojected back to the original dimensionality. The square of the reprojection error can then be used to determine if there are deviations or defects present.

### Marking Identified Deviant Repeating Units

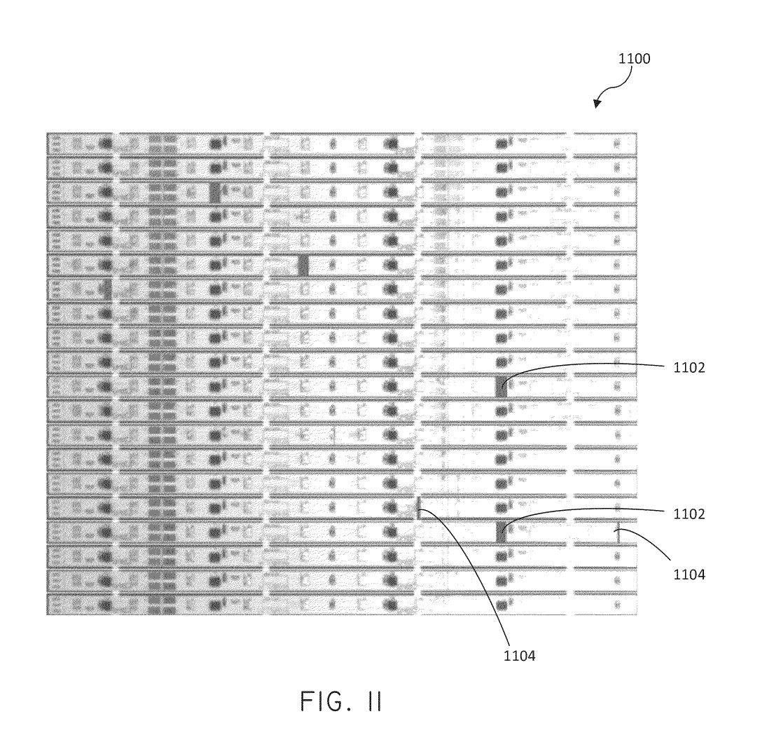

In various embodiments, the system can mark identified deviant repeating units. In some embodiments, the system can mark only the portions of the deviant repeating units that are deviant. In other embodiments, the system can mark the entire deviant repeating unit. As used herein, the term “mark” can include generation of data indicating which repeating units or portions thereof are deviant. The term “mark” can also include display of data indicating which repeating units or portions thereof are deviant. In some embodiments, a video image of the article and/or repeating units can be displayed and graphical elements can be include in order to visually indicate which of the repeating units include anomalies (aberrations or defects). In some embodiments, specific portions of the article and/or repeating units can be marked. By way of example, columns and rows, or portions thereof, can be marked if they include more than a predetermined threshold number of defects. Referring now to FIG. 11, a view of an article 1100 with marking superimposed thereon to indicate the location of the defects is shown. In this embodiment, defects 1102 are marked and the mark has a specific size corresponding to the relative physical size of the aberration. Defects 1104 are also marked and have a different size than the marking of defects 1102.

It will be appreciated that system in accordance with various embodiments herein can identify units that deviate from other repeating units with no prior training step. For example, in some embodiments, systems herein can be setup and can operate to identify units that deviate without the need for a system user to interface with the system and, in effect, train the system as to what distinguishes a deviating unit from a non-deviating unit. In some embodiments, this can allow for rapid deployment of the system. In some embodiments, it can allow for successive evaluation of heterogeneous types of units without additional steps such as recalibrating or retraining the system.

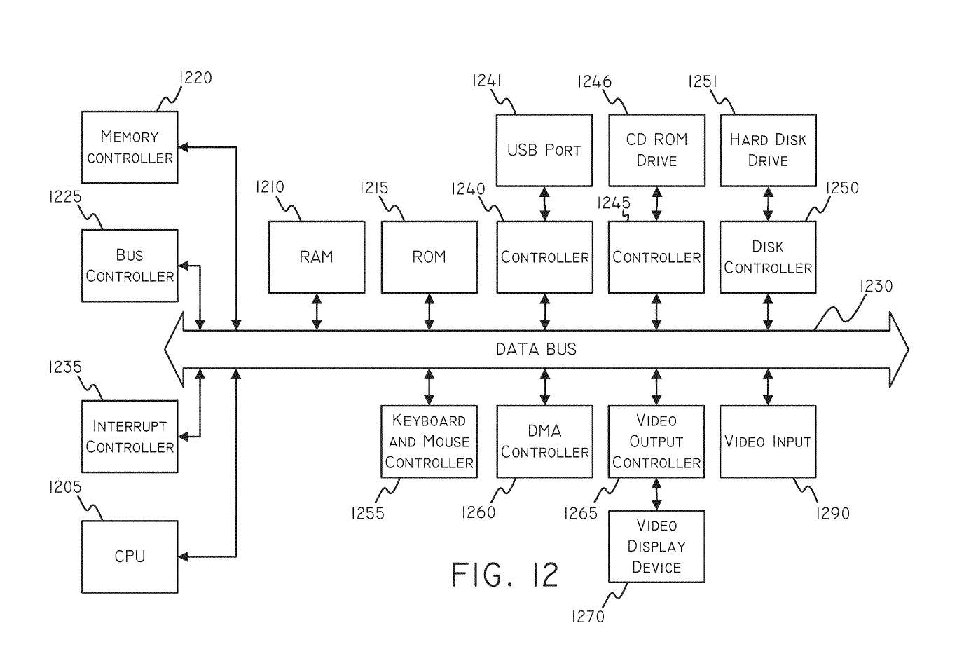

It will be appreciated methods described herein can be performed on various types of computing devices. Computing devices herein can include, but are not limited to, desktop computing devices, handheld computing devices, cloud computing devices, computing devices with client-server architecture, portable computing devices. In general, virtually any computing device that can execute instructions and receive and process video data can be used in accordance with embodiments herein. Referring now to FIG. 12, a diagram of various components that can be part of some computing devices is shown in accordance with some embodiments of the invention. The system includes a central processing unit (CPU) 1205 or processor, which may include a conventional microprocessor, random access memory (RAM) 1210 for temporary storage of information, and read only memory (ROM) 1215 for permanent storage of information. A memory controller 1220 is provided for controlling system RAM 710. A bus controller 1225 is provided for controlling data bus 1230, and an interrupt controller 1235 is used for receiving and processing various interrupt signals from the other system components.

In some embodiments one or more USB ports 1241 can be included, which are connected to bus 1230 by controller 1240. In some embodiments, a CD-ROM drive 1246 can be included, which is connected to bus 1230 by controller 1245, and a hard disk drive 1251, which is connected to bus 1230 by controller 1250. User input to the system can be provided by a number of devices. For example, a keyboard and mouse can connected to bus 1230 by keyboard and mouse controller 1255. DMA controller 1260 can be provided for performing direct memory access to system RAM 1210. A visual display is generated by a video controller 1265 or video output, which controls video display 1270. This description of elements is only provided by way of example and it will be appreciated that some computing devices may lack one or more elements illustrated in FIG. 12 and/or may include other elements. In some embodiments, methods herein can exist as instructions stored in memory as part of a computing device.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A self-learning machine vision system comprising:
a video input;
a processor in communication with the video input; and
a video output in communication with the processor;
wherein the processor is configured to
process video data from the video input;
identify a number of repeating units within the video data;
identify repeating units that deviate from the other repeating units;
wherein the system further displays an image of the repeating units through the video output with indicia to indicate identified deviant repeating units.

2. The self-learning machine vision system of claim 1, wherein the repeating units are co-temporal within the video data from the video input.

3. The self-learning machine vision system of claim 1, wherein the repeating units are circuit boards.

4. The self-learning machine vision system of claim 1, wherein the repeating units are circuit boards that are physically attached to one another.

5. The self-learning machine vision system of claim 1, wherein the repeating units are circuit boards arranged parallel to one another.

6. The self-learning machine vision system of claim 1, wherein the system identifies a number of repeating units within the video data through a process that includes formation of a grid pattern with which to segment the video data.

7. The self-learning machine vision system of claim 1, wherein the system identifies repeating units that deviate from the other repeating units through a process including background subtraction.

8. The self-learning machine vision system of claim 1, wherein the system identifies units that deviate from the other repeating units with no prior training step.

9. The self-learning machine vision system of claim 1, the video output comprising a video display.

10. The self-learning machine vision system of claim 1, the video input comprising a video camera.

11. A method of identifying defects in a stream of produced items comprising:
processing video data from a video input with a computing system;
identifying a number of repeating units within the video data;
identifying repeating units that deviate from the other repeating units by comparing the repeating with one another; and
displaying an image of the repeating units through a video output with indicia to indicate identified deviant repeating units.

12. The method of claim 11, wherein the repeating units are co-temporal within the video data from the video input.

13. The method of claim 11, wherein the repeating units are circuit boards.

14. The method of claim 11, wherein the repeating units are circuit boards that are physically attached to one another.

15. The method of claim 11, wherein the repeating units are circuit boards arranged parallel to one another.

16. The method of claim 11, wherein the system identifies a number of repeating units within the video data through a process that includes formation of a grid pattern with which to segment the video data.

17. The method of claim 11, wherein the system identifies repeating units that deviate from the other repeating units through a process including background subtraction.

18. The method of claim 11, wherein the system identifies units that deviate from the other repeating units with no prior training step.

19. The method of claim 11, the video output comprising a video display.

20. The method of claim 11, the video input comprising a video camera.
